(19) United States
(12) Patent Application Publication
(10) Pub. No.: US 2016/0297944 A1
(43) Pub. Date: Oct. 13, 2016

(54) PROCESS FOR PRODUCING AN INSULATION AND DRAINAGE SHEET AND INSULATION AND DRAINAGE SHEET

(71) Applicant: STO SE & CO. KGAA, Stühlingen (DE)

(72) Inventors: Martin HITZLER, Gottmadingen (DE); Andreas WEIER, Trossingen (DE); Eva KOHLER, Uhlingen-Birkendorf (DE); Gerald BURGETH, Lauchringen (DE); Alexander NÄGELE, Bonndorf (DE)

(21) Appl. No.: 15/036,339

(22) PCT Filed: Nov. 10, 2014
(86) PCT No.: PCT/EP2014/074160

§ 371 Date: May 12, 2016

(30) Foreign Application Priority Data
Nov. 13, 2013 (EP) 13192691.7

(51) Int. Cl. C08J 9/236; B29C 44/44; B29C 44/02; B29C 44/34

(52) U.S. Cl. CPC C08J 9/236; B29C 44/3461; B29C 44/445; B29C 44/02; C08J 2325/06; C08J 2433/06; C08J 2207/00; B29B 2009/163

(57) ABSTRACT

Method for manufacturing an insulation and drainage panel using foamable and/or pre-foamed polystyrene particles and an organic binder. The foamable and/or pre-foamed polystyrene particles are coated with the organic binder, filled into a mold and subjected to a final foaming process, wherein the foamable and/or pre-foamed polystyrene particles are coated using a powdery organic binder activated via the addition of moisture and/or heat, thereby forming a binder film that at least partially encases the polystyrene particles, which diminishes the expansion of the polystyrene particles during the final foaming process. The invention further relates to an insulation and drainage panel.

### CROSS REFERENCE TO RELATED APPLICATIONS

This is a U.S. national stage of application No. PCT/EP2014/074160, filed on Nov. 10, 2014. Priority under 35 U.S.C.§119(a) and 35 U.S.C.§365(b) is claimed from European Patent Application No. 13192691.7 filed on Nov. 13, 2013, the disclosure of which is also incorporated herein by reference

The invention relates to a method for manufacturing an insulation and drainage panel having the features in the preamble to claim 1. The invention further relates to an insulation and drainage panel having the features in the preamble to claim 13.

### BACKGROUND

Insulation panels that simultaneously have a drainage function are sufficiently known from prior art. Such insulation panels are predominantly used for thermal insulation in the outer walls of a building located underground. Their job is to keep moisture away from the building. In order to accomplish this, the surface of such insulation panels that faces the building often has a relief-like design, thereby resulting in cavities between the outer wall and the insulation panel through which the moisture can be transported away.

A thermal insulation panel that can be used as a drainage panel is known from DE 10 2004 033 535 A1, for example. At least one side of the panel has a profiling so as to realize the drainage function. For example, the profiling can encompass grooves or depressions worked into the surface of the panel. The latter serve as discharge channels, making it possible to realize the drainage function. If only one side of the panel is profiled, the profiled surface preferably comes to lie against the outer building wall to be insulated. The surface facing away from the outer building wall can be provided with a filter fleece to prevent the induction of soil.

Also known are drainage panels that can be used both in the soil and above the terrain for insulating an outer building wall. For example, such a panel may be gleaned from WO 2011/113956 A2. This publication discloses an insulation and drainage panel formed by foam pearls adhesively bonded with each other, wherein pores present between the pearls comprise a network for water runoff Therefore, the drainage function is handled by the panel material itself, eliminating the need for discharge channels. Another advantage to this is that the moisture inside the panel is removed, and thus kept away from the outer building wall to which the panel is applied, and also kept away from a coating applied to the panel in the form of plaster and/or paint, if such a coating is indeed provided. In order to help remove the moisture inside the panel, the panel proposed in this publication also exhibits a tapering free end, which comes to lie at the bottom while applying the panel to the outer building wall, and routes the moisture toward the middle of the panel like a funnel.

The aforementioned publication further discloses a method for manufacturing an insulation and drainage panel, in which foam pearls and a binder are mixed together, so that the binder yields a bond between the foam pearls once the binder has cured or dried.

Proceeding from the prior art mentioned above, the object of the present invention is to indicate a method for manufacturing an insulation and drainage panel that is open to water vapor diffusion and permeable to water due to a cohesive cavity volume, and also easy and inexpensive to manufacture. In addition, the insulation and drainage panel is to have good heat insulation properties and sufficient mechanical stability.

It is proposed that this object be achieved with the method having the features in claim 1. Advantageous further developments may be gleaned from the subclaims. Also indicated is an insulation and drainage panel that has the corresponding properties and is also easy and inexpensive to manufacture.

### Disclosure of the Invention

The method proposed for manufacturing an insulation and drainage panel provides for the use of foamable and/or pre-foamed polystyrene particles along with an organic binder. According to the invention, the foamable and/or pre-foamed polystyrene particles are coated with the organic binder, filled into a mold and subjected to a final foaming process, wherein the foamable and/or pre-foamed polystyrene particles are coated using a powdery organic binder, which is activated by adding moisture and/or heat, thereby forming a binder film that at least partially envelops the polystyrene particles, which diminishes the expansion of polystyrene particles during the final foaming process. The diminished expansion of polystyrene particles causes an interstitial volume to be retained between the particles, yielding a cohesive cavity volume. As a consequence, the panel fabricated in this way is permeable to water, and can be used as a drainage panel. At the same time, a stable bond is achieved between the polystyrene particles, since the particles are welded together during the final foaming process, even if on a reduced scale. Furthermore, the binder activated by adding moisture and/or heat causes the particles to bond, imparting additional stability to the panel.

While the binder film that at least partially encases the polystyrene particles during the final foaming process does result in a diminished expansion, an increase in the cell volume of the particles can be noted. Consequently, the insulation and drainage panel fabricated in this way further exhibits good thermal insulation properties. The extent to which the cell volume of the particles expands or enlarges can here be controlled by the percentage of binder.

The advantage to using the binder in powder form is that the binder only becomes activated by the addition of moisture and/or heat. Therefore, the particles can be coated with the binder before the actual final foaming process.

Foamable and/or pre-foamed polystyrene particles can be used as the starting material, and are coated with the powdery organic binder before the final foaming process. Coating takes place by bringing the powdery organic binder into contact with the foamable and/or pre-foamed polystyrene particles. Due to the surface roughness of the particles, establishing this contact causes the powdery binder to adhere to the particles. Contact is preferably established by mixing the starting materials, so as to ensure a uniform distribution of the binder.

When using foamable polystyrene particles, so-called polystyrene beads, coating can take place with the binder during a pre-foaming process. To this end, the polystyrene beads and binder powder are placed in a pre-foaming container, which is preferably simultaneously also designed as a stirrer or mixer. Movement in the pre-foaming container then helps to uniformly distribute the binder.

If water vapor is used as the heating medium during pre-foaming, which is routinely the case, this leads to a softening of the binder. Supported by the movement of polystyrene particles in the pre-foaming container, the softened binder wraps around the particles, so that the latter are at least partially encased by the binder.

The advantage to coating the foamable polystyrene particles with binder while pre-foaming is that only superficially adhering binder powder penetrates into the surface of the expanding polystyrene particles at first. The binder is simultaneously activated if water vapor is used as the heating medium. Therefore, the binder can also be activated by adding moisture and/or heat already before the actual final foaming process. If the foamable polystyrene particles are coated during pre-foaming, a relatively small amount of binder is already enough to achieve a uniform and effective coating.

When using pre-foamed polystyrene particles, so-called polystyrene pearls, the latter are first coated with the binder and then undergo final foaming in a mold. Coating again takes place by bringing the powdery organic binder into contact with the particles. The moisture and/or heat required to activate the powdery organic binder can be added during final foaming or already while coating.

Regardless of whether foamable or pre-foamed polystyrene particles are used, the moisture and/or heat required to activate the binder can be added in a variety of ways. One option was already mentioned in conjunction with foamable polystyrene particles as the starting materials, which were pre-foamed in a pre-foaming container using water vapor. In this case, the necessary moisture is provided by way of the water vapor.

In addition, the foamable and/or pre-foamed polystyrene particles can be moistened before coated with the powdery organic binder. If the powdery organic binder is then brought into contact with the moistened polystyrene particles, the moisture improves the adhesion of the powder binder to the particles.

Use can further be made of (still) moist, pre-foamed polystyrene particles, which contain a certain residual moisture as the result of pre-foaming. In this case, the moistening step is unnecessary. In addition, moistened, foamable and (still) moist or moistened, pre-foamed polystyrene particles can be used in combination.

In these instances, moisture is added by bringing into contact or mixing the powdery organic binder with the (still) moist or moistened polystyrene particles. The moisture improves the adhesion of the binder to the particles.

Since the addition of moisture while coating the polystyrene particles with the powdery organic binder can already trigger binder activation, the procedural steps of “coating the particles with the powdery organic binder” and “activating the binder” can coincide. For example, this is the case when coating takes place in the pre-foaming container, and the moisture and/or heat required to activate the binder is added by using water vapor as the heating medium. The chronological convergence of these steps proves advantageous, since the binder is softened when activated, and wraps around the particles in a thin layer that at least partially encases the particles. During the subsequent steps, in particular final foaming, this ensures the desired “corset-like” function of the binder, which prevents the particles from expanding unimpededly, and filling out the interstitial volume. In addition, the improved adhesion of the binder to the particles prevents the binder from filling out the interstitial volume during the final foaming process.

If the procedural steps of “coating the particles with the powdery organic binder” and “activating the binder” coincide, this leads to a significant simplification of the method for manufacturing an insulation and drainage panel. In addition, this has a favorable impact on the manufacturing costs. Furthermore, the method according to the invention can be implemented with already existing plants used to manufacture conventional polystyrene hard foam panels. Consequently, the method according to the invention can be implemented without engineering any new plants.

If exclusive use is made of polystyrene particles coated with binder before the final foaming process, the intermediate step of pre-foaming can be eliminated, so that the foamable polystyrene particles are only subjected to a foaming process. In this case, the foamable polystyrene particles are preferably moistened before coated with the powdery organic binder.

Use is preferably made of a dispersion powder, for example a dispersion powder based on homo-, co- or terpolymers of acrylates, styrene acrylate, vinyl acetate, ethylene, vinyl versatate, vinyl laurate, alkyl acrylates and/or vinyl chloride, as the powdery organic binder for coating the foamable and/or pre-foamed polystyrene particles. The advantage to using an organic binder is that the binder percentage can be reduced. This is because organic binders exhibit an elevated binding power by comparison to inorganic binders. A reduced binder percentage once again has a favorable impact on the size of the remaining interstitial volume, since the latter is not filled with excess binder. At the same time, a stable bond is achieved between the polystyrene particles. A binder combination of various organic binders can also be used in place of a single organic binder.

In addition, use is preferably made of 25 to 99.5% w/w, preferably 50 to 99% w/w, further preferably 75 to 98.5% w/w of foamable and/or pre-foamed polystyrene particles and 0.5 to 75% w/w, preferably 1 to 50% w/w, further preferably 1.5 to 25% w/w of powdery organic binder relative to the overall weight of the starting materials. The percentages are to be determined as a function of the respective specifically used starting materials. Since the degree to which the particles expand, and hence weld, can be controlled via the binder percentage, a certain importance is attributed to the binder percentage. At the same time, the binder is intended to trigger adhesive bonding between the particles. Furthermore, the binder percentage must be selected in such a way as to leave a sufficiently large interstitial volume between the particles, so that the desired cohesive cavity volume is formed.

An insulation and drainage panel manufactured based on the method according to the invention preferably exhibits polystyrene particles that have (incompletely) undergone final foaming, which are present as spherical and/or ellipsoid particles. In other words, the polystyrene particles subjected to final foaming have essentially retained their original shape as “beads” or “pearls”. This can again be attributed to the reduced expansion of particles during the final foaming process. This is because, when conventional, i.e., uncoated, polystyrene particles undergo final foaming, they usually become strongly deformed. They are then present in the subsequent panel as polyhedrons, which exhibit extensive contact areas with the adjacent particles. This results in a diminished interstitial volume, which also forms no cohesive cavity volume.

During the implementation of the method according to the invention, it is additionally proposed that, before coating or while coating the foamable and/or pre-foamed polystyrene particles with a powdery organic binder, fibers, fillers and/or additives, such as flame retardants, be incorporated into the latter. By including fibers, fillers and/or additives, the material-specific properties of the insulation and drainage panel fabricated according to this method can be appropriately influenced. Expanded graphite is preferably added as the flame retardant.

This applies similarly when using foamable and/or pre-foamed polystyrene particles that contain fibers, fillers and/or additives, such as flame retardants.

Expanded graphite is usually present in the form of coarse and/or angular particles, which ensure a good interlocking with the polystyrene particles. In comparison to fine, powdery flame retardants, using expanded graphite as the flame retardant thus has no negative influence on the stability of the insulation and drainage panel. In addition, expanded graphite is toxicologically harmless, as opposed to most conventional flame retardants.

In a further development of the invention, it is proposed that use be made of foamable and/or pre-foamed polystyrene particles with a shape other than a sphere, in particular an ellipsoid shape. This is because a shape other than a sphere facilitates the formation of a cohesive cavity volume between the particles when the latter are subjected to a pre-foaming and/or final foaming process.

It further proves advantageous for the foamable and/or pre-foamed polystyrene particles to be stored over a period of one day or several days at elevated temperatures, preferably at 40 to 80° C., and only be subjected to a final foaming process after the storage period. The propellant usually contained in the foamable and/or pre-foamed particles, preferably pentane, escapes during a corresponding storage period before final foaming. Depleting the propellant once again causes the polystyrene particles to expand less strongly during final foaming. Consequently, this measure can also facilitate the formation of a cohesive cavity volume.

The subject matter of the invention further relates to an insulation and drainage panel encompassing partially welded, expanded polystyrene particles, which were also adhesively bonded with an organic binder, wherein an interstitial volume present between the polystyrene particles forms a cohesive cavity structure, which makes the panel open to water vapor diffusion and permeable to water. The fact that the expanded polystyrene particles present in the panel are both welded and adhesively bonded yields an especially stable bond between the particles. As a consequence, the proposed insulation and drainage panel exhibits a high mechanical stability. At the same time, the cohesive cavity volume provides it with a drainage function, which permits its use as a drainage panel without having to incorporate discharge channels in a surface of the panel, as routinely the case in conventional drainage panels. The moisture to be kept away from the building is removed inside the panel via the cohesive cavity volume. At the same time, the panel has an insulating function, since it contains expanded polystyrene particles that have to some extent undergone final foaming, which exhibit an insulating cell volume.

The expanded polystyrene particles are preferably present as spherical and/or ellipsoid particles in the panel. Consequently, the particles having been subjected to final foaming only exhibit a slight change in shape relative to the original shape of the used polystyrene beads and/or polystyrene pearls. This can be attributed to the fact that the polystyrene beads and/or polystyrene pearls only experienced a slight enlargement of volume during the final foaming process by comparison to uncoated polystyrene particles, so as to obtain an interstitial volume between the polystyrene particles that forms a cohesive cavity volume. The degree to which the particles are welded together is also reduced by the diminished volume enlargement during the final foaming process, since the spherical or ellipsoid particles having undergone final foaming only exhibit contact areas that are essentially isolated or confined to small surface areas. Nonetheless, a stable bond between the particles is achieved via the cured binder that at least partially encases the particles, wherein the binder percentage selected is small enough to keep the interstitial volume largely free of binder.

In a preferred embodiment of the insulation and drainage panel according to the invention, the content of binder measures 0.1 to 20% v/v, preferably 0.2 to 15% v/v, further preferably 0.3 to 10% v/v in relation to the overall volume of the panel. Among other things, the percentage of binder depends on the specifically used starting materials, in particular on the type of used organic binder. Preferably used as the organic binder is a dispersion powder, for example a dispersion powder based on homo-, co- or terpolymers of acrylates, styrene acrylate, vinyl acetate, ethylene, vinyl versatate, vinyl laurate, alkyl acrylates and/or vinyl chloride. The advantage to using an organic binder is that the binder percentage can be reduced. This is because organic binders exhibit an elevated binding power by comparison to inorganic binders. A reduced binder percentage once again has a favorable impact on the size of the remaining interstitial volume, since the latter is not filled with excess binder. At the same time, a stable bond is achieved between the polystyrene particles. A binder combination of various organic binders can also be used in place of a single organic binder.

In addition, the insulation and drainage panel according to the invention can contain fibers, fillers and/or additives, for example flame retardants. In particular, included additives can optimize the material-specific properties of the insulation and drainage panel. If the insulation and drainage panel does contain a flame retardant, then it preferably contains expanded graphite as the flame retardant. It is further proposed that the insulation and drainage panel be fabricated based on the method according to the invention described above. In other words, use was made of foamable and/or pre-foamed polystyrene particles that were coated with a powdery organic binder, filled into a mold and subjected to a final foaming process. Adding moisture and/or heat before the actual final foaming process triggers an activation of the binder. The activated binder softens, and forms a binder film that at least partially encases the polystyrene particles and diminishes the expansion of polystyrene particles during the final foaming process. In this way, the binder causes a cohesive cavity volume to form between the polystyrene particles.

The moisture and/or heat required for activating the binder was preferably added while coating the polystyrene particles with the binder. This is because doing so improves the adhesion of the binder to the particles. The binder adhering to the particles causes the particles to become adhesively bonded, and further allows a certain degree of welding between the particles during the final foaming process. Consequently, an insulation and drainage panel fabricated according to this method exhibits a high mechanical stability.

An insulation and drainage panel fabricated based on the method according to the invention further exhibits very good thermal insulation properties. This is because subjecting the polystyrene particles to final foaming results—even if only to a limited extent—in an expansion, and hence enlargement of the particle cell volume. As a consequence, the thermal insulation properties can be improved by comparison to manufacturing processes in which the pre-foamed polystyrene particles do not go through a final foaming process, but are rather only adhesively bonded. At the same time, the expansion of particles is confined to a level ensuring that an interstitial volume remains between the welded and adhesively bonded particles, forming a cohesive cavity volume. The cohesive cavity volume once again causes the insulation and drainage panel fabricated according to this method to be open to water vapor diffusion and permeable to water. The method according to the invention along with insulation and drainage panels fabricated according to the latter will be described in greater detail below based on examples.

### EXAMPLE 1

85% w/w of EPS beads were mixed with 15% w/w of dispersion powder (terpolymer base comprised of ethylene, vinyl laurate and vinyl chloride), and pre-foamed with the addition of pressure (1 bar) and heat (100° C.), wherein water vapor served as the heating medium. In the process, the dispersion powder softened, and formed a polymer film on the pre-foamed EPS pearls. The coated and pre-foamed EPS pearls were subsequently dried briefly in a fluidized bed dryer.

Nine liters of the coated and pre-foamed EPS pearls were filled into a mold with the dimensions 30 cm×30 cm×10 cm and subjected to final foaming under pressure (1) and heat (100° C.), wherein water vapor was once again used as the heating medium. After a reduction in pressure, the molded part was removed from the mold, and dried over a period of one week at room temperature.

The molded part fabricated in this way exhibited a thermal conductivity λ according to DIN EN 12667 of 0.029 W/(mK) and a density p according to DIN EN 1602 of 27 kg/m³, as well as a tensile strength perpendicular to the panel surface according to DIN EN 1607 of 179 kPa.

The water permeability of the molded part was also tested. Water applied to the surface of the molded part penetrated through the latter immediately and completely. A drainage effect was clearly in evidence.

### EXAMPLE 2

85% w/w of freshly pre-foamed EPS pearls were moistened and thoroughly mixed with 15% w/w of dispersion powder (base comprised of ethylene-vinyl acetate copolymer) and then dried.

Nine liters of the coated, pre-foamed EPS pearls were filled into a mold with the dimensions 30 cm×30 cm×10 cm and foamed with the addition of pressure (1 bar) and heat (100° C.), wherein water vapor served as the heating medium. After a reduction in pressure, the molded part was removed from the mold, and dried over a period of one week at room temperature.

The molded part fabricated in this way exhibited a thermal conductivity λ according to DIN EN 12667 of 0.030 W/(mK) and a density p according to DIN EN 1602 of 28 kg/m³, as well as a tensile strength perpendicular to the panel surface according to DIN EN 1607 of 136 kPa.

The water permeability of the molded part was also tested. Water applied to the surface of the molded part penetrated through the latter immediately and completely. A drainage effect was clearly in evidence.

### EXAMPLE 3

Both the starting materials and how they were processed corresponded to Example 1, except that lenticular EPS beads were used, and pre-foamed into EPS lenses. In terms of the properties of thermal conductivity, density and tensile strength, the molded part fabricated in this way was no different than the molded part in Example 1. However, it did exhibit slightly enhanced drainage properties.

### EXAMPLE 4

Both the starting materials and how they were processed corresponded to Example 1, except that, after dried in the fluidized bed dryer, the coated and pre-foamed EPS pearls were stored for a period of two days at a temperature of 70° C., so as to deplete the propellant. This was followed by final foaming according to Example 1.

The molded part fabricated in this way exhibited a thermal conductivity λ according to DIN EN 12667 of 0.030 W/(mK) and a density p according to DIN EN 1602 of 27 kg/m³, as well as a tensile strength perpendicular to the panel surface according to DIN EN 1607 of 174 kPa. The drainage properties could once again be slightly improved by comparison to Example 1.

### EXAMPLE 5

70% w/w of EPS beads were mixed with 10% w/w of dispersion powder (base comprised of vinyl acetate-ethylene copolymer) and 20% w/w of expanded graphite, and pre-foamed with the addition of pressure (1 bar) and heat (100° C.), wherein water vapor served as the heating medium. In the process, the dispersion powder softened, and formed polymer film on the pre-foamed EPS pearls, which fixed the expanded graphite onto the surface of the EPS pearls. The coated and pre-foamed EPS pearls were subsequently briefly dried in a fluidized bed dryer.

Nine liters of the coated pre-foamed EPS pearls loaded with expanded graphite were filled into a mold with the dimensions 30 cm×30 cm×10 cm and subjected to final foaming under pressure (1 bar) and heat (100° C.), wherein water vapor was once again used as the heating medium. After a reduction in pressure, the molded part was removed from the mold, and dried over a period of one week at room temperature.

The molded part fabricated in this way exhibited a thermal conductivity λ according to DIN EN 12667 of 0.031 W/(mK) and a density p according to DIN EN 1602 of 28 kg/m³, as well as a tensile strength perpendicular to the panel surface according to DIN EN 1607 of 168 kPa. The drainage properties could once again be slightly improved by comparison to the molded part in Example 1.

### Reference Example

Nine liters of uncoated, pre-foamed EPS pearls (grain size 3-8 mm, bulk density 0.015-0.016 g/cm³) were now filled into a mold with the dimensions 30 cm×30 cm×10 cm and blocked with the addition of pressure (1 bar) and heat (100° C.), wherein water vapor served as the heating medium that streamed extensively through the mold from top to bottom for 10-15 seconds. After a reduction in pressure, the molded part was removed from the mold, and dried over a period of one week at room temperature.

The molded part fabricated in this way exhibited a thermal conductivity λ according to DIN EN 12667 of 0.029 W/(mK) and a density p according to DIN EN 1602 of 16 kg/m³, as well as a tensile strength perpendicular to the panel surface according to DIN EN 1607 of 173 kPa.

The water permeability of the molded part was also tested. Water applied to the surface of the molded part could not penetrate through the latter. The molded part was impermeable to water.

By comparison to a conventional insulation panel made out of polystyrene hard foam (reference example), a molded part (Examples 1 to 5) fabricated based on the method according to the invention thus exhibits a drainage function, which can be attributed to the present interstitial volume that forms a cohesive cavity volume. At the same time, the molded parts fabricated based on the method according to the invention further exhibit very good thermal insulation properties, as well as a high mechanical strength.

1. A method for manufacturing an insulation and drainage panel using foamable and/or pre-foamed polystyrene particles and an organic binder,
characterized in that the foamable and/or pre-foamed polystyrene particles are coated with the organic binder, filled into a mold and subjected to a final foaming process, wherein the foamable and/or pre-foamed polystyrene particles are coated using a powdery organic binder activated via the addition of moisture and/or heat, thereby forming a binder film that at least partially encases the polystyrene particles, which diminishes the expansion of the polystyrene particles during the final foaming process.

2. The method according to claim 1,
characterized in that the foamable and/or pre-foamed polystyrene particles are moistened before coated with the powdery organic binder.

3. The method according to claim 1,
characterized in that the moisture for activating the powdery organic binder is added by mixing the powdery organic binder with moist, foamable and/or pre-foamed polystyrene particles.

4. The method according to claim 1,
characterized in that the moisture and/or heat for activating the powdery organic binder is added in a pre-foaming or final foaming process, preferably in the form of water vapor.

5. The method according to claim 1,
characterized in that use is made of a dispersion powder, for example a dispersion powder based on homo-, co- or terpolymers of acrylates, styrene acrylate, vinyl acetate, ethylene, vinyl versatate, vinyl laurate, alkyl acrylates and/or vinyl chloride, as the powdery organic binder for coating the foamable and/or pre-foamed polystyrene particles.

6. The method according to claim 1,
characterized in that use is made of 25 to 99.5% w/w, preferably 50 to 99% w/w, further preferably 75 to 98.5% w/w of foamable and/or pre-foamed polystyrene particles and 0.5 to 75% w/w, preferably 1 to 50% w/w, further preferably 1.5 to 25% w/w of powdery organic binder relative to the overall weight of the starting materials.

7. The method according to claim 1,
characterized in that, before coating or while coating the foamable and/or pre-foamed polystyrene particles with a powdery organic binder, fibers, fillers and/or additives, such as flame retardants, are incorporated into the latter.

8. The method according to claim 7,
characterized in that expanded graphite is added as the flame retardant.

9. The method according to claim 1,
characterized in that use is made of foamable and/or pre-foamed polystyrene particles that contain fibers, fillers and/or additives, such as flame retardants.

10. The method according to claim 9,
characterized in that use is made of foamable and/or pre-foamed polystyrene particles that contain expanded graphite as the flame retardant.

11. The method according to claim 1,
characterized in that use is made of foamable and/or pre-foamed polystyrene particles with a shape other than a sphere, in particular an ellipsoid shape.

12. The method according to claim 1, characterized in that foamable and/or pre-foamed polystyrene particles are stored over a period of one day or several days at elevated temperatures, preferably at 40 to 80° C., and subjected to a final foaming process after the storage period.

13. An insulation and drainage panel, encompassing partially welded, expanded polystyrene particles, which are additionally adhesively bonded via an organic binder, wherein an interstitial volume present between the poly styrene particles forms a cohesive cavity structure, which causes the panel to be open to water vapor diffusion and permeable to water.

14. The insulation and drainage panel according to claim 13,
characterized in that the expanded polystyrene particles are preferably present as spherical and/or ellipsoid particles in the panel.

15. The insulation and drainage panel according to claim 13,
characterized in that the content of binder measures 0.1 to 20% v/v, preferably 0.2 to 15% v/v, further preferably 0.3 to 10% v/v in relation to the overall volume of the panel.

16. The insulation and drainage panel according to claim 13,
characterized in that fibers, fillers and/or additives, such as flame retardants, can additionally be included.

17. The insulation and drainage panel according to claim 16,
characterized in that expanded graphite is included as the flame retardant.

18. The insulation and drainage panel according to claim 13,
characterized in that the panel was fabricated based on a method according to claim 1.
